(19) United States
(12) Patent Application Publication
(10) Pub. No.: US 2018/0158135 A1
(43) Pub. Date: Jun. 7, 2018

(54) Methods and systems for instant local offers and exchanges for daily situations

(71) Applicant: Ravish Patwardhan, New York City, NY (US)

(72) Inventor: Ravish Patwardhan, New York City, NY (US)

(21) Appl. No.: 15/618,114

(22) Filed: Jun. 8, 2017

Related U.S. Application Data
(60) Provisional application No. 62/347,594, filed on Jun. 8, 2016.

(51) Int. Cl. G06Q 30/08

(52) U.S. Cl. CPC G06Q 30/08

(57) ABSTRACT

The present invention creates a method for instant requests and acceptances of transactions, whereby the App allows messaging of an “offer” being sent as “notifications” to all those able to accept the offer, and then either accept the offer, or counterbid; alternatively, it also allows one in a potentially desirable position (or having a desirable good) to offer the same by notifying within a geographical, demographic, or other means, to try to acquire an acceptor. This will be either consummated using cash, electronic payment, or other system.

### CROSS-REFERENCE TO RELATED APPLICATIONS

This application claims the benefit and priority of U.S. provisional patent application Ser. No. 62/347,594, filed Jun. 8, 2016, entitled “Methods and systems for instant local offers and exchanges for daily situations”, the contents of which is hereby incorporated by reference in its entirety.

### FIELD OF THE INVENTION

This invention relates generally to methods and systems for creating a mobile and/or other computer based application whereby a seeker sends out a request for a service or position to occupy, and a person who can either fulfill that service or exchange the position s/he is in with that person can accept the offer, such as with an electronic payment, a direct cash payment, and/or other compensation mediated through said method and/or system.

### BACKGROUND OF THE INVENTION

It is often desirable, in everyday circumstance, to “swap places” with someone, for example, who is ahead in a long line at a coffee shop, for a one-to-one exchange, willing to pay what the amount is that someone is willing to accept for such a transaction.

### SUMMARY OF THE INVENTION

The present invention may generally include an App which, when activated, outlines to an audience of its choosing (based upon available mobile phone characteristics and/or other parameters) “those willing to accept a proposal” based upon a notification. Rather than ask each person in line, which is time-consuming and/or impractical depending on the situation, an app and/or other computer-augmented method may be utilized which offers to these people via “notifications” the offer discretely, and upon acceptance, allows the transaction to be consummated via a cash payment (either in person or via electronic payment services such as PayPal or Scale) can be provided;

Such a transaction would not necessarily affect others beyond the parties executing the transaction, as one place (or service) would be exchanged for another.

In one aspect of the invention, the seeker requests, to a specified audience or generally, a transaction to be fulfilled, with what s/he is willing to pay (the ask).

In another aspect, the potential acceptor is able to designate a “bid” for the spot s/he is selling to surrounding attendees.

The potential acceptors of the transaction are then able to either accept the transaction, subject to ability to pay, or counter-bid.

In a further aspect, the app utilizes real-time or near real-time location information of the user(s) to match users for deals within specified distances and/or areas. In some embodiments, the app utilizes GPS or mobile/WiFi network location services for location information of users.

In another aspect, the app includes real-time notifications of available deals and/or updates to ongoing deals.

In a further aspect, the app may run in the background on a device and generate notifications of available deals and/or updates to ongoing deals to inform the user.

The present invention together with the above and other advantages may best be understood from the following detailed description of the embodiments of the invention and as illustrated in the drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIGS. 1 and 1a illustrate embodiments of the screens that the seeker may have (via wire diagrams);

FIGS. 2a, 2b and 2c illustrate embodiments of screens that the acceptor may view (via wire diagrams)—view notification, accept notification, or counterbid, respectively;

FIGS. 3, 3a, illustrate views of the screens that the bidder (already in a desirable position) may have (via wire diagrams);

FIG. 4 illustrates a conceptual flowchart of overall components, in summary;

FIG. 5 illustrates a login screen of the app of the present invention;

FIG. 5a illustrates a menu including links for settings, ongoing deals, starting a new deal and completed transactions;

FIG. 5b illustrates a form in the app to create a new deal for either offering or seeking something with options for distance from the user;

FIG. 5c illustrates a screen in the app to display ongoing deals in an area; and

FIGS. 5d, 5e, 5f and 5g illustrate a chat screen in the app for communicating with other users about a deal.

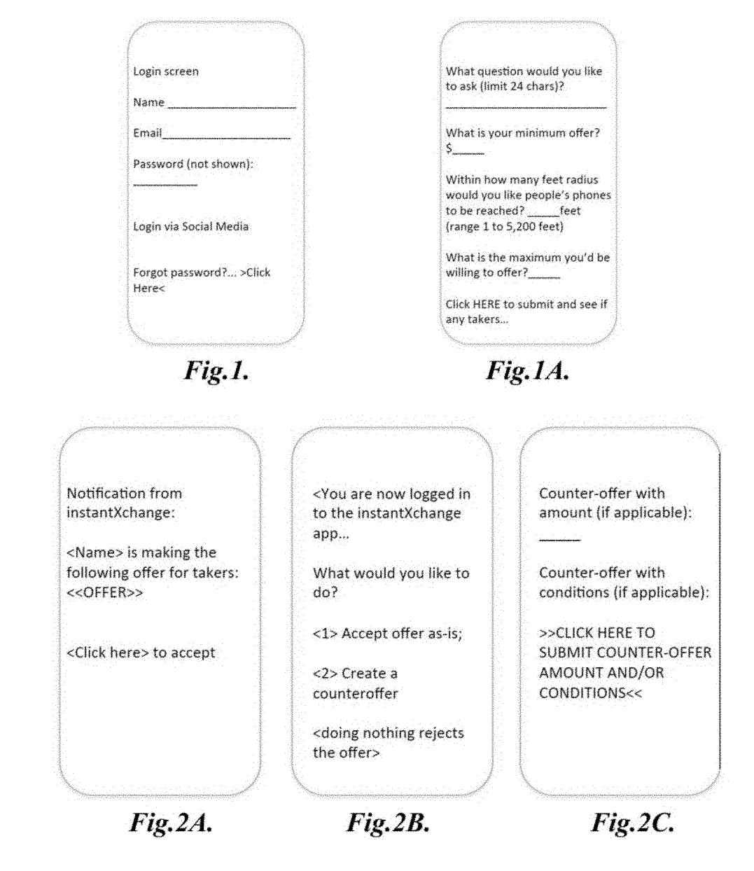

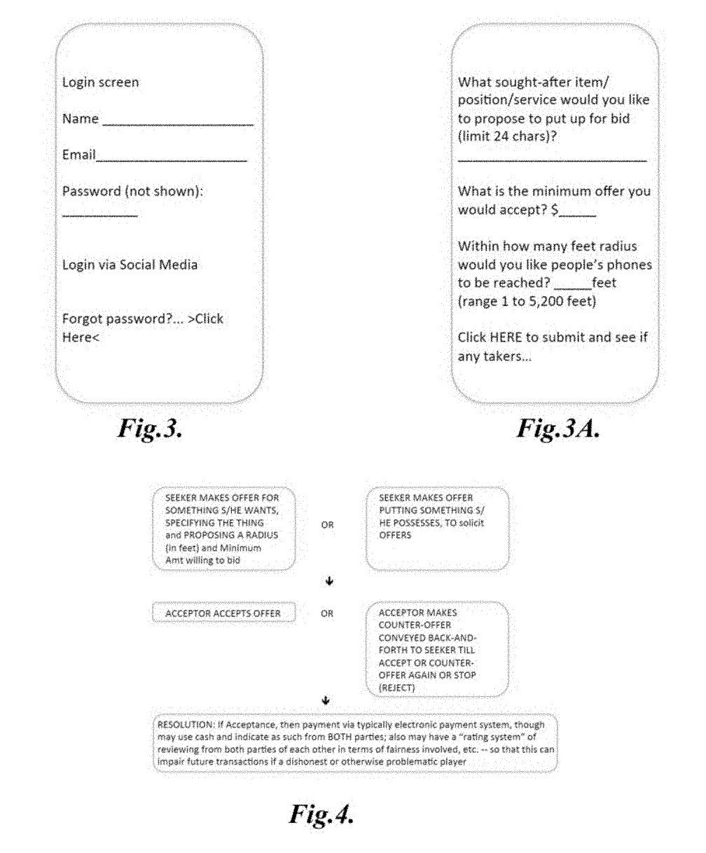

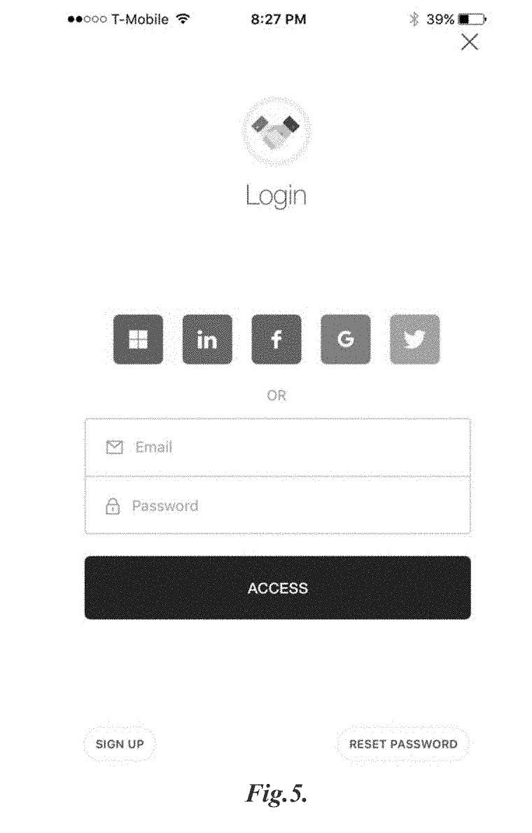

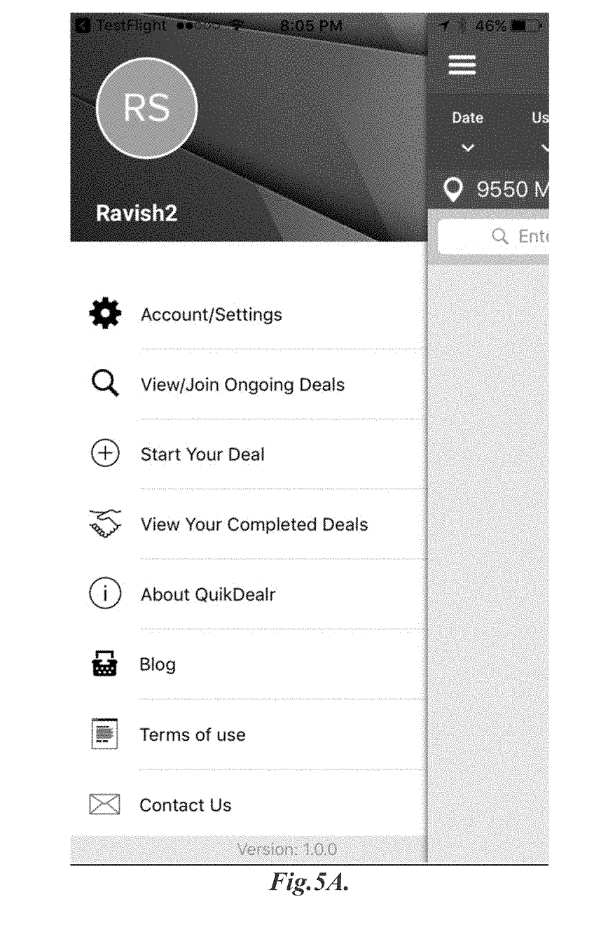

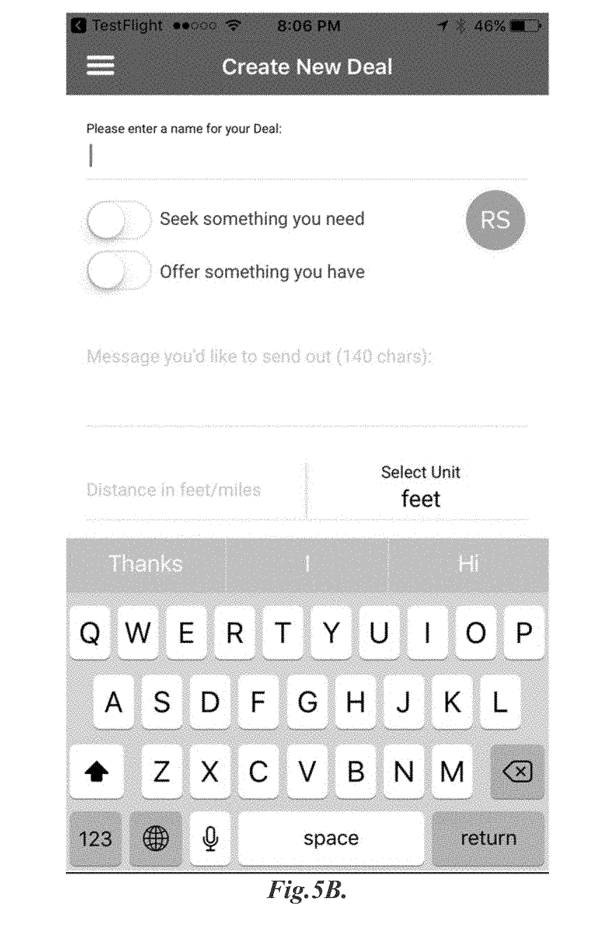

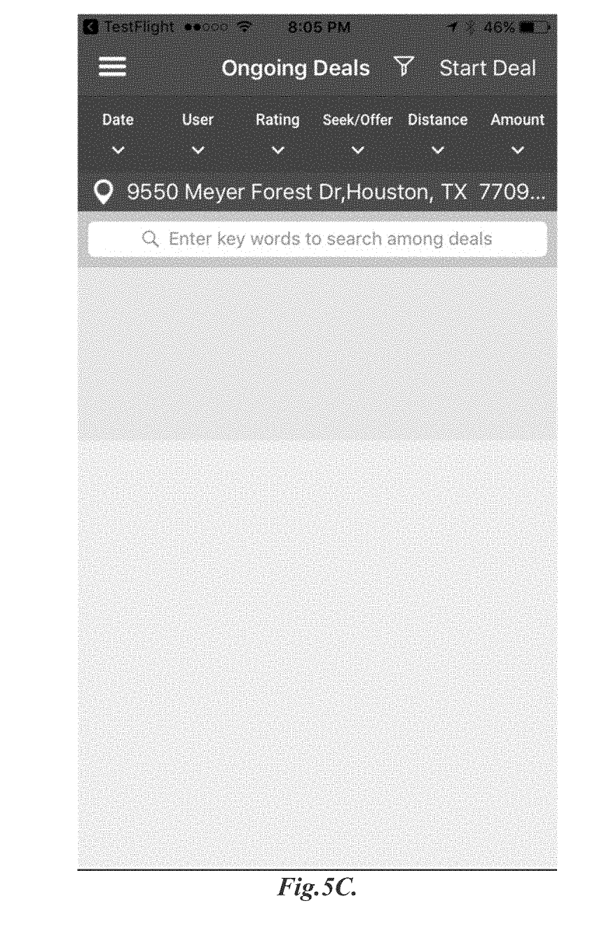

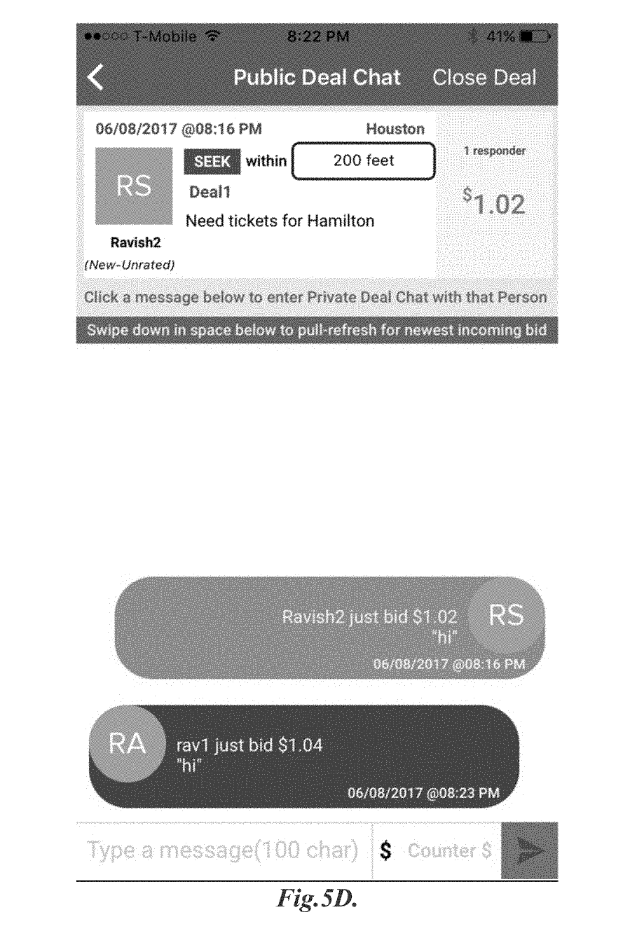

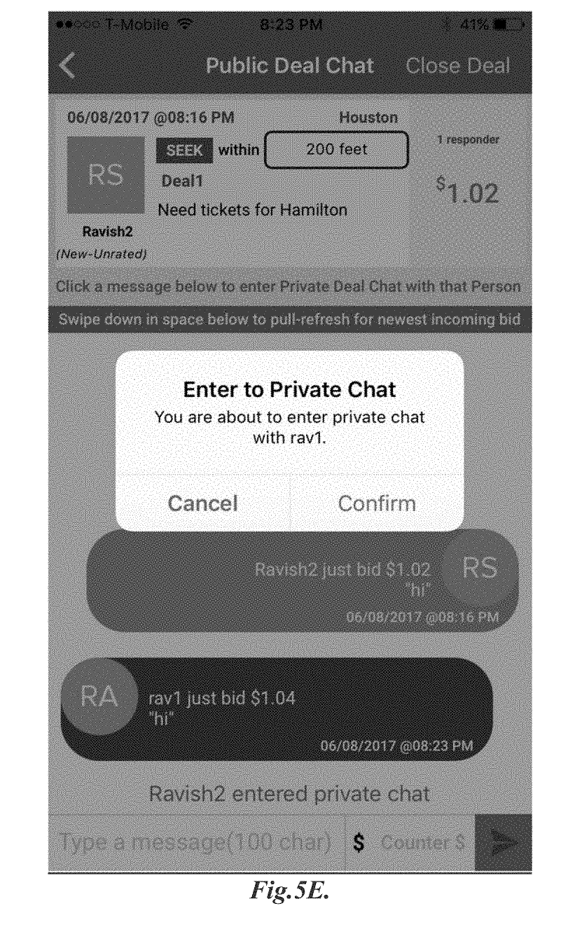

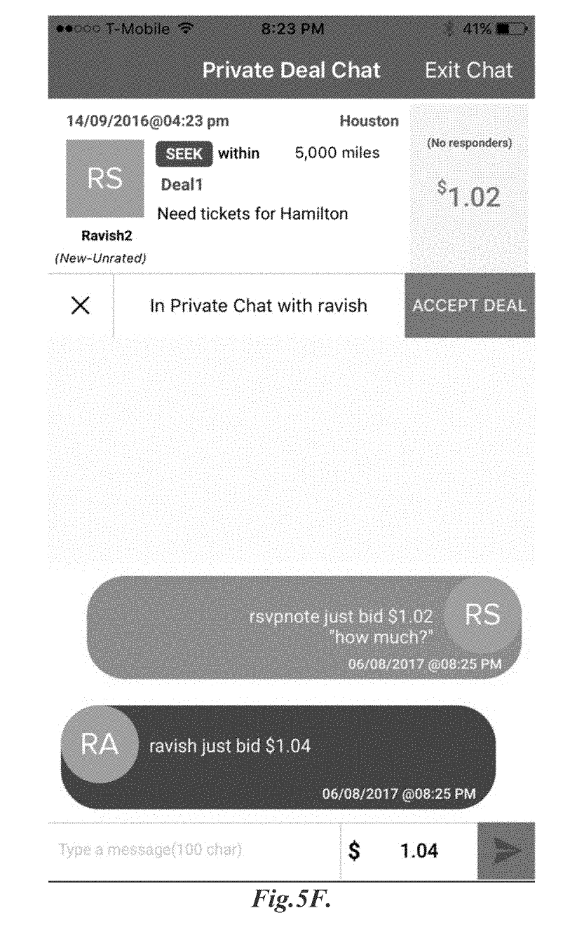

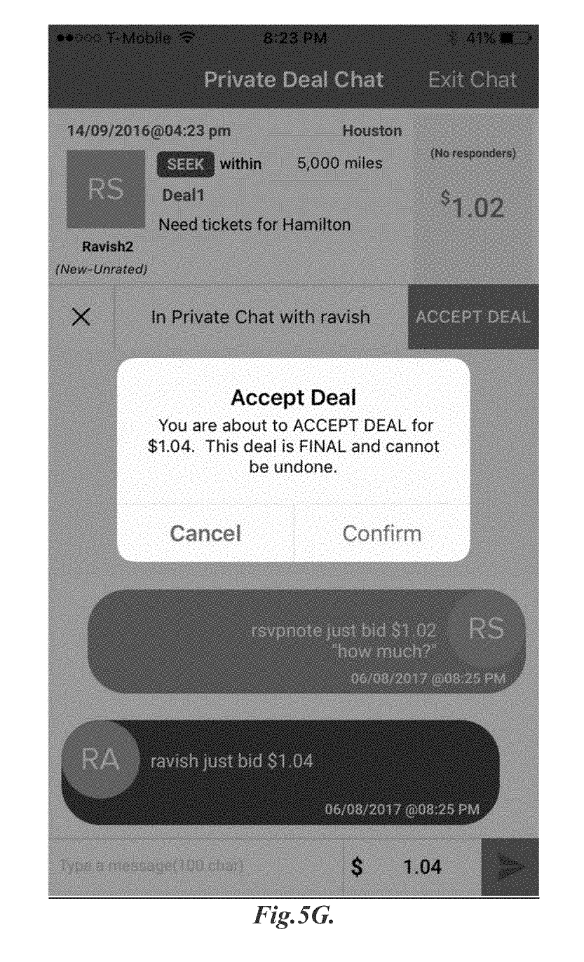

### DETAILED DESCRIPTION OF THE INVENTION

The detailed description set forth below is intended as a description of the presently exemplified methods, devices and compositions provided in accordance with aspects of the present invention, and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention relates to methods and systems for a connecting different people with a task performance App for exchanging and/or modifying fulfillment of services. The present invention more particularly relates to transactions in a desired local, whether in proximity or in category.

Other details are as noted above, and each can be expanded upon under “Summary of Invention, Brief Description, and Figures” sections—each expanded upon with intricacies for user interface for each using party.

### Example of App Operation to a Deal

The back-end of the app begins by user authentication and log-in, followed by input by the user of deal specifications, such as whether the user is offering something or wishes to receive something, the location or distance from the user for the deal to occur and/or an amount as applicable. The deal specifications are then transmitted to other users of the app, such as within the specified location or distance, or to users who are actively viewing the given location. The location/distance specifications may generally be governed by location services on the devices of the users, such as GPS, mobile network location services, WiFi location services, and/or any other appropriate method, which may generally operate in real time or near real time. Users who fit the parameters of the deal may generally receive a notification from the app on their device while the app is open or also including, if enabled, when the app is running in the background. The deal specifications may then be transmitted to such users for their viewing, after which they may participate in the deal, such as by entering a chat regarding the deal, such as to bid for fulfillment of the deal. In general, in public chat for a deal, bidding and counterbidding with general discussion may be enabled by the app. A user may also enter into a private chat with the deal originator, such as to close the deal and arrange for payment and/or fulfillment of the deal between the two specific users. Payments may be affected by any appropriate service or method, such as in person payments, utilizing online payment services through an appropriate API, such as PayPal or Scale, credit card transactions, direct bank transactions and/or any other appropriate method or service. In general, it may be desirable to utilize secured transactions whenever possible, such as through PCI-compliant methods.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

1. A method for consummating a deal between two parties comprising:
providing at least two users with an app operating on a mobile device, said app including a user interface for creating a proposed deal and for viewing and/or selecting to participate in available deal(s);
providing said users with a communication interface to propose bids and/or counterbids for completing one of said available deals;
providing said users with a means for providing payment for one of said users in exchange for fulfilling one of said available deals;
wherein said app utilizes the location services of said mobile device to allow said users to specify locations or areas of interest for deal making and for searching for potential users in a vicinity for potentially consummating one of said available deals.
